(19) United States
(12) Patent Application Publication
(10) Pub. No.: US 2005/0087610 A1
(43) Pub. Date: Apr. 28, 2005

(54) Visually significant marking in position encoded glyph carpets

(76) Inventor: Guy de Warrenne Bruce Adams, Stroud (GB)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/693,649

(22) Filed: Oct. 27, 2003

(51) Int. Cl. G06K 19/06

(52) U.S. Cl. 235/494

(57) ABSTRACT

A visually significant image is created using information encoding glyphs and an alphabet of glyphs. Each glyph has a specified optical intensity and is adapted to encode information by an optically detectable property of the glyph. The information encoding glyphs are selected and positioned so that the bulk optical properties of an aggregate of the glyphs create the visually significant image. The glyph shape defines both the optical intensity and the encoding. In an alternative embodiment, the glyphs are dynamically created to suit the particular visually significant image which is to be created.

### CROSS-REFERENCE TO RELATED APPLICATIONS

Not Applicable.

### STATEMENT REGARDING FEDERALLY FUNDED RESEARCH OR DEVELOPMENT

Not Applicable.

### INCORPORATION BY REFERENCE OF MATERIAL SUBMITTED ON COMPACT DISC

Not Applicable.

### BACKGROUND OF THE INVENTION

1. Technical Field

The present invention relates to methods and apparatus for creating data-encoded glyph carpets which also incorporate visually significant material. Visually significant material means primarily graphical information which is visible and meaningful to a human eye, for example watermarks or background graphics. Visually significant material may also contemplate graphical information which is detectable at other wavelengths and at other resolutions. More particularly, although not exclusively, the present invention relates to methods and apparatus for creating position or data encoded data-glyph background carpets to incorporate graphical and/or textual material which is visually explicable.

2. Background Art

Data-encoded glyph carpets are well known and are employed for a variety of purposes including embedding digital data into graphical images and encoding position data onto a printed page. The latter method allows the absolute or relative position of an optical cursor or similar I/O device to be determined by imaging a portion of the glyph carpet and decoding the position information which is embedded in the glyphs at that point.

There are many situations where it is desirable to combine visually significant information with data-encoded background glyph carpets. For example, when filling in a printed form it is necessary to have graphics printed on a page to provide visual cues as to what information is to be entered in the form and where.

In applications where digital information is to be encoded into a graphical image itself, it is a basic requirement that there be some way primarily of encoding the visually significant information (i.e., the image) with the digital data. An example of such an application is where digital data relating to a printed photograph such as the date, author and title, is to be embedded into the image itself. This can be done according to the techniques described in U.S. Pat. No. 5,315,098. However the available digital encoding space is limited in that each glyph can only take on one of two binary values. Thus it may not be possible to encode large quantities of data into such a graphical image. The available information density may also be limited by the inherent visual characteristics of the image itself. Complex images with a large optical intensity range may require more shades than can be created by halftoning the basic ‘/’ ‘\’ glyphs.

In U.S. Pat. No. 5,315,098, a visually significant image is created using halftone elements shaped as forward-slashes “/” and back-slashes “\”. The digital data is encoded into the image by modulating the glyph angle. That is, a 1 can be encoded as a ‘/’ and a 0 as a ‘\’. Thus, an array of these glyphs can be used to encode strings or sequences of ones and zeroes thereby allowing digital data to be embedded into the visually significant graphical feature.

U.S. Pat. No. 6,570,104 uses a data encoding scheme based on glyph optical intensities. Here, the data is encoded into the data-glyphs not by varying the position or shape of the glyph on the page, but by modulating the size of the glyph.

In one example described in U.S. Pat. No. 6,570,104, each optically detectable glyph element corresponds to a circularly symmetric dot having a visual intensity which is modulated by increasing the size of the dot. That is, a larger, and hence darker, dot corresponds to a 1 and a smaller, lighter dot, to a 0. Thus binary digital data can be encoded into the background glyph carpet. In this case, superimposing a visually significant image onto the data-enabled glyph carpet would be impossible as the variations in the glyph optical intensity which would normally be used to create the visually significant image are used to provide the binary encoding.

This represents contradictory requirements of data-encoded glyph carpets. A background glyph carpet should be visually unobtrusive and great pains are taken to ensure that the optical characteristics of the background glyph carpet do not interfere with any overprinted visually significant information.

It would therefore be highly advantageous to provide a technique which would allow a data-encoded background glyph carpet to be optically modulated to create relatively high-quality visually significant graphics while simultaneously providing a sufficiently large data encoding space.

### SUMMARY OF THE INVENTION

In one aspect, the invention provides for a method of creating a visually significant image using information encoding glyphs and an alphabet of glyphs, wherein each glyph has a specified optical intensity and is adapted to encode information by the shape of the glyph. The method includes the step of selecting and positioning said information encoding glyphs so that the bulk optical properties of an aggregate of the glyphs create the visually significant image, wherein the glyph shape defines both the optical intensity and the encoding.

The encoding values are preferably a function of the symmetry properties of a plurality of glyphs.

In a preferred embodiment, the method uses a glyph alphabet, wherein each glyph is uniquely optically identifiable and has a bulk optical property, and includes the steps of arranging at least a subset of said glyphs on a page so that in any given area, the bulk optical properties of an aggregate of said plurality of glyphs forms an visually significant image or image portion, wherein the shape of the plurality of glyphs is used to encode information.

Preferably, the plurality of glyphs forms a background glyph carpet.

In one embodiment, the background glyph carpet is adapted to encode the position of a unique location on a page within a logical page-space, the extent of which is defined by the specific encoding technique.

In an alternative embodiment, the background glyph carpet is adapted to encode digital information into the visually significant image.

Such digital information may correspond to data relating to the image, multimedia data, textual data or any other information which can be recorded in the background glyph carpet.

The selection of encoding glyphs occupying a specified portion of the visually significant image may be governed by the maximum or minimum optical intensity of the resulting visually significant image.

Where the minimum optical intensity of the specified portion of the visually significant image is sufficiently low as to reduce the encoding possibilities below a specified useful value, the visually significant image may incorporate an optical DC offset, or greyscale offset, thereby increasing the encoding space in said specified region by allowing additional glyphs to be used in that area.

The offset preferably corresponds to applying uniform grey background on the visually significant image.

The maxima and minima optical intensity of the visually significant image may be such that insufficient encoding can be applied to any region, the contrast of the visually significant image may be reduced.

Preferably the optically detectable properties of the glyphs are the symmetry properties of the glyphs which preferably correspond to rotation and/or reflection symmetry attributes of said glyphs.

Preferably in dark areas of the visually significant image, optically dark glyphs dominate the encoding scheme in said dark area, while in light areas of the visually significant image, optically light glyphs dominate the encoding scheme in said light area.

In an alternative aspect, the glyph alphabet is dynamically created as a function of the optical characteristics of the desired visually significant image.

The dynamically created glyph alphabet is preferably created so that at a specified level of optical resolution, aggregates of the glyphs at that specified level of optical resolution approximate the optical intensity distribution of the desired visually significant image.

In a preferred embodiment, the glyphs are positioned so that their optical centre of gravity coincides with the vertices of a grid.

The invention also provides an article incorporating visually significant information and encoded information generated according to the method as hereinbefore defined.

### BRIEF DESCRIPTION OF THE DRAWINGS

The present invention will now be described by way of example only and with reference to the drawings in which:

FIG. 1 is an illustration of an exemplary set of shape encoded glyphs;

FIG. 2 is an illustration of an exemplary shift-encoding a glyph;

FIG. 3 is an illustration of an exemplary visually significant modification to a position-encoded glyph carpet; and

FIG. 4 is an illustration of optical intensity and encoding properties of the glyph alphabet shown in FIG. 1.

### DETAILED DESCRIPTION OF THE DRAWING

According to a preferred embodiment of the invention, data-encoding is achieved by locating uniquely shaped glyphs on the vertices of a regular grid.

In conjunction which this, visually significant data is modulated into the data-enabled glyph background carpet by selecting from the shape “alphabet”, shapes which exhibit the desired optical intensity characteristics so that the desired visually significant image is created on the page when all of the glyphs are printed.

The selection of the glyphs for both encoding the visually significant information and for encoding the digital data will depend on the properties of the glyph alphabet. That is, the more optically shape-unique glyphs in the alphabet, the more freedom there is in selecting the glyphs for optical encoding, the better the visual quality of the image and more information can be encoded on the same carpet area.

This can be understood by considering at a single glyph with, for example 8, unique rotation and reflection orientations. Such a glyph is indicated in FIG. 1 by the numeral 8. This glyph can encode 8 different values encoding 3 bits of information, i.e.; one per unique orientation/reflection. However, for all those orientations, the glyph will have the same bulk optical property which it can contribute to the visually significant appearance of the background glyph bed.

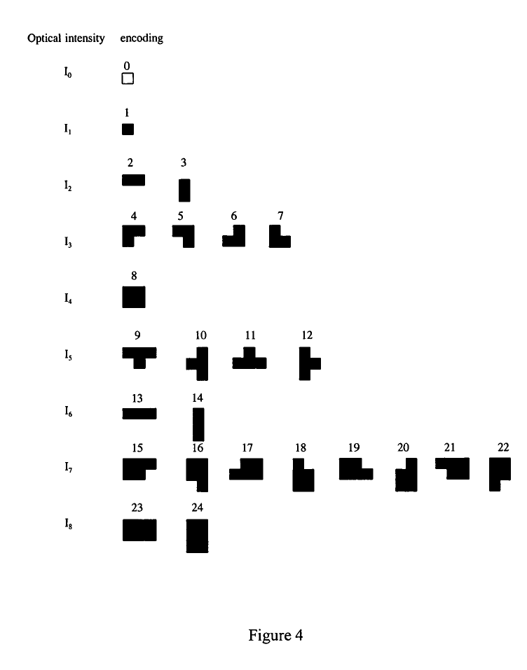

Referring to FIG. 1, an example of a complete set of shape glyphs is shown. In this embodiment, the shape encoding is based on the rotation and reflection symmetry properties of the glyphs. For each glyph in the set, the number of rotation encodings is indicated by the numeral appearing below the glyph. For example for glyph number four, there are four unique rotations or orientations which the glyph can assume. However, at the same time, the optical characteristics are such that only a single intensity I₃ (see FIG. 4) is produced for any one of those encodings. This ignores, for the moment, any local optical effects produced by the local neighbourhood of the glyph when in place on the glyph bed.

In contrast, glyph number seven has only two unique orientations. An intensity/encoding matrix for the alphabet of FIG. 1 is illustrated in FIG. 4. Here, each optically unique glyph is shown representing 7 different optical intensities Iᵢ.

The process of encoding the digital data according to the shape of the glyph and the visually significant data according to the effective intensity of the glyph can be complex. However, a suitable alphabet of optically unique shapes such as those shown in FIG. 4 can be selected. Using their rotation/reflection symmetry properties to encode the digital data into the glyph bed in conjunction with selecting glyphs of suitable intensity to be placed in certain regions of the image, a high quality image which has data-encoding capability exceeding those available in the art can be produced.

Referring again to FIG. 4, a range of intensities from a white blank grid location I₀, to a dark 6-dot glyph I₈ is available. Finer control over the intensities may be obtained by using intermediate intensities or by using a glyph with the same number of ink dots, but arranged differently. For example, a more dispersed pattern such as I₆ will appear darker due to dot gain than a concentrated glyph I₃ with the same number of ink dots. This feature can be used to create visually significant graphics with a relatively large number of shades.

Rotation and reflection provide a way to define a set of optically unique shapes. It is possible, however, that glyphs with arbitrary shapes such as tiling or labyrinthine shapes might be viable so long as they are uniquely recognisable to an optical detection system. To this end, it is envisaged that a detection system based on general shape classification may achieve this end. Such a technique would allow a very fine degree of control over the apparent optical brightness of the glyphs. There may be a trade-off between the detection reliability in this regard. However, such a technique is considered to be within the scope of the invention in its broadest form.

It is envisaged that in the preferred embodiment, each glyph would have its optical centre of gravity coincident with a corresponding vertex of the background glyph placement grid.

To construct the visually significant, data-encoded image, the visually significant data (i.e., the image which is to be viewed) is initially evaluated to determine the optical “dynamic range” which is required in order to at least functionally render the visually significant image in a recognisable form to the human eye.

By way of example, at one extreme an image which is entirely composed of white regions and black regions would be incapable of encoding any information. White-space implies that no ink can be placed in that part of the image. Completely black regions imply that there would be no optical detail in a completely inked area which could be used to encode the digital data. Therefore, in evaluating the visually significant image an effective optical intensity range would need to be determined whereby the lightest regions would be made up of the least optically intense glyphs and the darkest regions would be made of the most optically intense glyphs. In the case of the image made up entirely of black and white areas, this might require a greyscale offset to allow encoding to be embedded in the graphic. White areas could be adjusted to be light grey and black areas could be adjusted to be dark grey. The intervening intensity levels would be made up of combinations of the glyphs from the selected glyph alphabet.

In a first example, it is envisaged that a system would have at its disposal a predetermined glyph alphabet such as that shown in FIG. 1 which has a set of specified optical and data encoding properties.

In such a situation, the visually significant image may be “built” according to a constraint window which would represent, for any particular area of the image, the set or subset of shapes which can be used to encode the data into the background glyph carpet for that region.

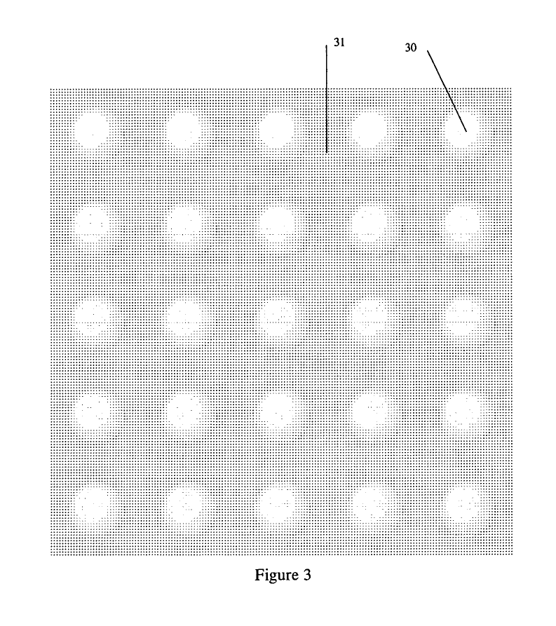

If the image is broken down into optically significant regions, this is the set of shapes which provide the required intensity range. This would define and constrain the available data encodings. For example, referring to FIG. 3, the sub-regions in the centre of the large light-coloured dots 30 in FIG. 3, would have a restricted set of glyph shapes available as the dominant optical characteristic of these sub-regions is lightness. Dark glyphs will be unsuitable for use in these regions.

The intervening dark areas 31 would be able to use different and a possibly larger set of glyph shapes as darker shapes would be allowable given that these regions are in general of higher optical density.

As before, the range of low to high contrast area may be normalised or shifted to extend the range of available glyph shapes and therefore encodings. That is, if a large light-coloured region in the visually significant image unduly restricts the available scope of the light glyph alphabet, the overall optical intensity may be given a DC offset thus darkening the light regions. This offset will be limited by the particular application which is contemplated as well as the required quality or fidelity of the resultant visually significant image.

Where the image performs a substantially “mechanical” function, such as form filling, an optical DC offset is unlikely to hamper a user's interpretation of the form and thus an image could be compensated to extend the available glyph alphabet.

This technique allows the production of visually significant images which have improved quality, resolution and background data encoding density.

It is envisaged that more complex implementations of the invention may dynamically create the glyph (shape) alphabet depending on the visual characteristics of the image which is desired.

Such a glyph generation algorithm could operate as follows.

The desired visually significant image would be analysed to determine the optical intensity range, the intensity resolution, the image size, the page size and other optical characteristics which might be affected by the selection and distribution of the shape glyphs in the background glyph carpet. That is, selecting the number and characteristics of the shape codes which could be used to construct the visually significant image, while simultaneously providing a useful degree of encoding by means of each shapes symmetry properties. The bulk optical characteristics would then be compared with the desired data encoding characteristics. This latter constraint may include factors such as the required logical page space size or the position resolution of a pen/cursor-based optical position sensing device which is to be used to detect position codes encoded into the background glyph carpet.

The glyph shapes would then be generated according to an algorithm or selected from a predetermined glyph shape vocabulary. Algorithms might be based on fractal shape generation or other mathematical methods which can be used to generate a set of shapes with the required symmetry and bulk optical properties.

A significant advantage of the present invention is that it solves the problem of overprinting glyph carpets. Overprinting is where a pre-printed background glyph carpet has visually significant material simply overprinted thereon to provide visual cues or information linked to the functions of the various page locations etc. Inks which are optically transparent to the sensing device, but which are opaque to the human eye may be used. Alternatively, redundancy or error correction techniques can be used. However, these may not be ideal as large scale overprinting may render large areas of the page unusable for data encoding in the background glyph carpet and may cause the optical detection device to get lost when it images various parts of the page.

Referring again to FIG. 1, the range of encoding can be seen to be relatively large. This will depend on the symmetry qualities of the glyph shapes. In FIG. 1 there are 25 unique shapes. Assuming that the constraints of the visually significant material are not onerous in terms of limiting the shapes which can be used for a particular sub-region of the image, this would provide ample combinations to encode position information or data in a relatively large logical page space.

For example, the smallest reliably printable mark is a 2 by 2 cluster of dots at the native printer resolution. Conservatively if it assumed that a 600 dpi laser/inkjet/other engine is used, this yields a mark of 0.0847×0.0847 mm. If we then take the largest shape in the illustrated alphabet—I₈ which consists of 3 by 2 marks, then the shape has a size of 0.25 by 0.17 mm.

The grid ideally should have a pitch that is divisible by the printer resolution but also the grid needs to place the shapes a distance apart as well as allow selection of the correct optical density for the visually significant content. If the grid pitch is 0.677 mm and if an area (tile) that contains 4 by 4 shapes is used to encode position, then the theoretical maximum is 25¹⁶=2.3×10²² (with the existing illustrated alphabet of 25 characters).

Any constraints imposed by the visually significant marking as well as other parameters such as orientation, will reduce this figure, however it is possible to minimize this by using a larger alphabet if the reduction in encoding needs to be minimized.

On the grid pitch chosen we could use a much larger alphabet. That is, any shape whose edges were within a 7 by 7 boundary (of the basic 2 by 2 mark). This would result in a rich alphabet of many thousands of characters allowing significant choice of marking density either side of a nominal ‘halfway’ point, with the encoding reducing closer to either light or dark.

The above grid pitch is 8 of the basic (2 by 2) marks. Thus if we set targets of 10% to 75% density of marking, this means that the optical density of the alphabet would span a range of 6 marks to 48 (49-1). This number of marks ensures that the encoding is maintained at the light and dark extremes. It is noted that the theoretical maximum, which is limited by the darker extreme with 49 shapes, increases to 1.1×10²⁷.

The alphabet of FIG. 4 does not illustrate all the possible shapes and associated permutations that are possible with 6 marks. There exist at least 90 in theory, however some of these may not be suitable to use as they could generate unwanted visual sub patterns.

The limit of 49 shapes in the above example may be increased by using another mark within the shape region. The maximum optical density will reduce to 73% (as we are at the dark end of the optical density) but the number of possible shapes increases to 49².

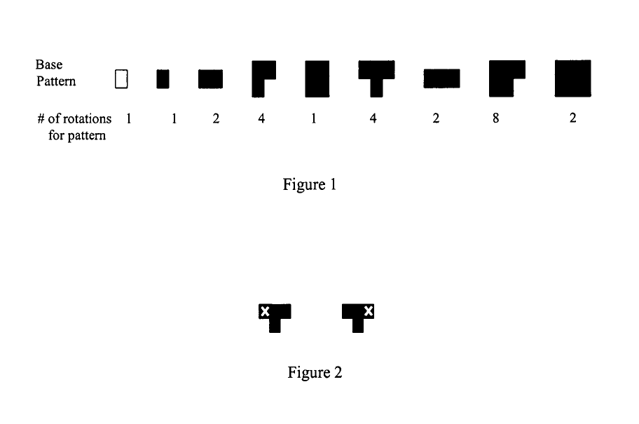

Data encoding by way of exploiting the symmetry or uniqueness properties of the shape alphabet may be extended by considering shape shifting as opposed to locating the optical centre of gravity of the glyphs on the grid vertices. Referring to FIG. 2, glyph number six is shown aligned with a grid vertex on its left arm and on its right arm. Such a shift could be detected in relation to either the expected position in of the glyphs optical centre of gravity in relation to the grid, or by comparison with other nearby glyphs. In either case, shape shifting provides another level of data encoding.

Shape shifting might also be used in conjunction with rotation or reflection encoding as a way of providing a finer degree of control over the visually significant image construction. To this end, if the symmetry or shape-based encoding is used to encode the data into the glyphs, it is possible that some variability might be allowed in the actual location of the shape glyphs. That is, the shape glyph is allowed to occupy a “fuzzy” location. The shape and thus the encoding and therefore data value will be recognised while the “fuzziness” can be used to contribute to improving the optical fidelity of the visually significant image. Thus, the location variability could be used to dynamically alter the ink distribution. For example, where some increase intensity is required, that is, more ink per unit page area, but limitations in respect of the available alphabet of shapes does not allow the use of bigger glyphs, selected glyphs might be shifted or aligned slightly so that the bulk optical effect is to increase the ink intensity in a specified area without affecting the data encoding.

This may be less useful in absolute or relative position applications where the encoding of the glyph represents the precise position where the glyph is placed. However, if the task is to encode data into an image, this may be a satisfactory method of improving the fidelity of the visually significant image.

Although the example shown is based on a square primitive or square ink dot being used to construct the shape alphabet, it is envisaged that more complex shapes may be suitable depending on the required degree of symmetry and bulk optical behaviour. This will also depend on the capability of the printer hardware which is used to print the graphics. Examples of other shapes include labyrinthine forms which may have strong symmetry characteristics, but weak bulk optical properties. Alternatively, more simple shapes could be used whose bulk optical properties are highly sensitive to the shapes orientation. Also, coloured visually significant images could be constructed according to the same principles as those outlined above with relatively little modification.

It is envisaged that the optical characteristics of the shape alphabet would be capable of detection using contemporary sensing devices. Factors such as the required field of view, correction for device orientation and tilt could be compensated for according to methods analogous to those described in the background documents referred to above. It is also noted that shape or symmetry encoding could be used in conjunction with a number of prior art techniques, most notably that of U.S. Pat. No. 6,548,768. In this case, the displacement direction of a dot in relation to a virtual grid provides the required data encoding. Applying symmetry or shape encoding to the dot could extend the encoding capability of that prior art technique in a way which is decoupled from the displacement encoding.

Although the invention has been described by way of example and with reference to particular embodiments it is to be understood that modifications and/or improvements may be made without departing from the scope of the appended claims.

Where in the foregoing description reference has been made to integers or elements having known equivalents, then such equivalents are herein incorporated as if individually set forth.

1. A method of creating a visually significant image using information encoding glyphs and an alphabet of glyphs, each glyph having a specified optical intensity and each glyph being adapted to encode information by the shape of the glyph, the method including the step of:
selecting and positioning the information encoding glyphs so that the bulk optical properties of an aggregate of the glyphs create the visually significant image, wherein the glyph shape defines both the optical intensity and the encoding.

2. The method as claimed in claim 1 further including creating said alphabet of glyphs.

3. A method as claimed in claim 1 wherein the information is encoded by symmetry properties of a plurality of glyphs.

4. A method as claimed in claim 1 wherein the plurality of glyphs forms a background glyph carpet.

5. A method of creating a visually significant image using information encoding glyphs and a glyph alphabet wherein the each glyph is uniquely optically identifiable and has a bulk optical property, the method including the step of:
arranging at least a subset of said glyphs on a page so that in any given area, the bulk optical properties of an aggregate of said plurality of glyphs forms a visually significant image or image portion.

6. The method as claimed in claim 5 further including defining said glyph alphabet.

7. The method as claimed in claim 5 further including encoding information by using the shape of the plurality of glyphs.

8. A method as claimed in claim 3 wherein the plurality of glyphs forms a background glyph carpet.

9. A method as claimed in claim 8 wherein the background glyph carpet is adapted to encode the position of a unique location on a page within a logical page-space, the extent of which is defined by the specific encoding technique.

10. A method as claimed in claim 8 wherein the background glyph carpet is adapted to encode digital information into the visually significant image.

11. A method as claimed in claim 10 wherein the encoded digital information corresponds to data relating to the image, multimedia data, textual data or any other information which can be recorded in the background glyph carpet.

12. A method as claimed in claim 5 wherein the encoding glyphs occupying a specified portion of the visually significant image depend on the maximum or minimum optical intensity of the resulting visually significant image.

13. A method as claimed in claim 5 wherein the visually significant image incorporates an optical DC offset or greyscale shrinkage, where the minimum optical intensity of the specified portion of the visually significant image is sufficiently low as to reduce the encoding possibilities below a specified useful value, whereby the encoding space in said specified portion is increased.

14. The method as claimed in claim 13 inserting additional glyphs in said portion.

15. A method as claimed in claim 13 wherein the DC offset preferably corresponds to applying uniform grey background on the visually significant image.

16. A method as claimed in claim 12 wherein the contrast of the visually significant image is reduced, where the maxima and minima optical intensities of the visually significant image are such that insufficient encoding can be applied to any region.

17. A method as claimed in claim 5 wherein the glyphs are distinguishable by symmetry properties of the glyphs corresponding to at least one of rotation and reflection symmetry attributes.

18. A method as claimed in claim 5 further comprising causing optically dark glyphs to dominate the dark areas of the visually significant image, and optically light glyphs to dominate the encoding scheme in light areas of the visually significant image.

19. A method as claimed in claim 2 wherein the glyph alphabet is dynamically created as a function of the optical characteristics of the desired visually significant image.

20. A method as claimed in claim 19 wherein the dynamically created glyph alphabet is created so that at a specified level of optical resolution, aggregates of the glyphs at that specified level of optical resolution approximate the optical intensity distribution of the desired visually significant image.

21. A method as claimed in claim 1 wherein the glyphs are positioned so that their optical centre of gravity coincides with vertices of a grid.

22. A method as claimed in claim 5 wherein the glyphs are positioned so that their optical centre of gravity coincides with vertices of a grid.

23. An article incorporating visually significant information and encoded information generated according to the method of claim 1.

24. An article incorporating visually significant information and encoded information generated according to the method of claim 5.

25. An encoded surface having an array of glyphs applied thereon, each glyph having a specified optical intensity and each glyph encoding information by the shape of the glyph, the selection and position of the glyphs being such that the bulk optical properties of an aggregate of the glyphs creates a visually significant image, the glyph shape defining both the optical intensity and the encoding.
